(19) United States
(12) Patent Application Publication
(10) Pub. No.: US 2026/0156586 A1
(43) Pub. Date: Jun. 4, 2026

(54) ELECTRONIC DEVICE

(71) Applicant: Samsung Electronics Co., Ltd., Suwon-si (KR)

(72) Inventors: Byeongtak JO, Suwon-si (KR); Gangminh LEE, Suwon-si (KR); Dujeong LEE, Suwon-si (KR); Jonghwan LEE, Suwon-si (KR); Kyunam CHO, Suwon-si (KR)

(21) Appl. No.: 19/404,150

(22) Filed: Dec. 1, 2025

(30) Foreign Application Priority Data
Dec. 4, 2024 (KR) 10-2024-0178612

(51) Int. Cl. H04W 52/36; H04B 1/3827; H04W 52/26

(52) U.S. Cl. CPC H04W 52/367; H04B 1/3838; H04W 52/267

(57) ABSTRACT

An electronic device includes a transceiver that transmits and receives a signal via wireless communication, and at least one processor that adjusts at least one of a transmission power of the wireless communication and a transmission speed of the wireless communication based on specific absorption rate (SAR) information associated with electromagnetic waves generated by the electronic device. The at least one processor determines an initial target transmission power of the wireless communication based on the SAR information, determines whether the initial target transmission power is less than a current transmission power of the wireless communication, determines whether a connection of the wireless communication of the electronic device is maintainable at the initial target transmission power, and adjusts at least one of the transmission power and the transmission speed of the wireless communication based on the determination of whether the connection of the wireless communication is maintainable.

### CROSS-REFERENCE TO RELATED APPLICATION

This application claims priority to Korean Patent Application No. 10-2024-0178612, filed in the Korean Intellectual Property Office on Dec. 4, 2024, the entire contents of which are hereby incorporated by reference.

### BACKGROUND

### Field

The present disclosure relates to an electronic device, and more particularly, to an electronic device for managing the absorption rate of electromagnetic waves while maintaining a wireless communication connection.

### Description of Related Art

An electronic device supporting wireless communication (e.g., a user equipment (UE)) may radiate electromagnetic waves (e.g., wireless communication signals). Electromagnetic waves may have harmful effects on the human body, for example, when electronic devices are in close proximity to the human body. Due to the possibility of these electromagnetic waves causing harm, many countries and international organizations are establishing regulations to limit the electromagnetic waves emitted by electronic devices to certain levels.

Specific Absorption Rate (SAR) is an indicator of the amount of electromagnetic waves emitted from an electronic device and absorbed by the human body. Electronic devices may be designed to not exceed the SAR standard. For example, an electronic device may be designed to monitor the absorption rate in real time and adjust a transmission power based on the SAR. However, when reducing the transmission power, the transmission coverage may be reduced, thereby increasing the risk of disconnection of the existing wireless communication connections, which may negatively affect user experience and communication quality.

The above-described information is intended to enhance understanding of the background of the present disclosure and may include information that does not constitute prior art.

### SUMMARY

The present disclosure relates to an electronic device for addressing the above issues.

The issues to be addressed by the present disclosure are not limited to those described above, and other issues not mentioned may be clearly understood by those skilled in the art from the description of the disclosure below.

According to some aspects, an electronic device comprises a transceiver configured to transmit and receive a signal via wireless communication; and at least one processor configured to adjust at least one of a transmission power of the wireless communication and a transmission speed of the wireless communication based on specific absorption rate (SAR) information associated with electromagnetic waves generated by the electronic device, wherein the at least one processor is further configured to: determine an initial target transmission power of the wireless communication based on the SAR information, determine whether the initial target transmission power is less than a current transmission power of the wireless communication, in response to a determination that the initial target transmission power is less than the current transmission power, determine whether a connection of the wireless communication of the electronic device is maintainable at the initial target transmission power, and adjust at least one of the transmission power and the transmission speed of the wireless communication based on the determination of whether the connection of the wireless communication is maintainable at the initial target transmission power.

According to some aspects, an electronic device comprises a transceiver configured to transmit and receive a signal via wireless communication, and at least one processor configured to adjust at least one of a transmission power of the wireless communication and a transmission speed of the wireless communication based on specific absorption rate (SAR) information associated with electromagnetic waves generated by the electronic device, wherein the at least one processor is further configured to determine an initial target transmission power of the wireless communication based on the SAR information, determine whether the initial target transmission power is equal to or greater than a current transmission power of the wireless communication, in response to a determination that the initial target transmission power is equal to or greater than the current transmission power, determine whether a connection of the wireless communication of the electronic device is maintainable at a transmission power less than the initial target transmission power, and adjust the transmission power of the wireless communication based on the determination of whether the connection of the wireless communication is maintainable at the transmission power less than the initial target transmission power.

According to some aspects, a method of operating an electronic device comprises determining an initial target transmission power of a wireless communication based on specific absorption rate (SAR) information associated with electromagnetic waves generated by the electronic device, determining whether the initial target transmission power is less than a current transmission power of the wireless communication, in response to determining that the initial target transmission power is less than the current transmission power, determining whether, upon reducing the current transmission power to the initial target transmission power, a connection of the wireless communication of the electronic device is maintainable, and adjusting at least one of a transmission power and a transmission speed of the wireless communication based on the determination of whether the connection of the wireless communication is maintainable at the initial target transmission power.

According to various embodiments of the present disclosure, a wireless communication connection is maintainable while managing specific absorption rate (SAR), thereby improving user experience and communication quality.

The effects that may be obtained through the present disclosure are not limited to those described above. Any technical effects not mentioned will be clearly understood by those skilled in the art from the description of the disclosure set forth below.

### BRIEF DESCRIPTION OF THE DRAWINGS

The above and other embodiments and features of the present disclosure will become more apparent by describing in detail example embodiments thereof with reference to the attached drawings, in which:

FIG. 1 is a diagram illustrating an example of a network environment including an electronic device according to one embodiment of the present disclosure;

FIG. 2 is a block diagram illustrating an example of an electronic device according to one embodiment of the present disclosure;

FIG. 3 is a block diagram illustrating an example of a program module according to one embodiment of the present disclosure;

FIG. 4 is a diagram showing an example of a time-specific absorption rate graph according to one embodiment of the present disclosure;

FIG. 5 and FIG. 6 illustrate a wireless communication system according to one embodiment of the present disclosure;

FIG. 7 is a block diagram illustrating an example of an electronic device according to one embodiment of the present disclosure;

FIG. 8 is a block diagram illustrating an example of the internal configuration of a processor according to one embodiment of the present disclosure;

FIGS. 9 to 11 are flowcharts illustrating examples of an operation method of an electronic device for managing the specific absorption rate (SAR) according to one embodiment of the present disclosure;

FIG. 12 is a diagram showing an example of a lookup table according to one embodiment of the present disclosure;

FIG. 13 is a flowchart showing another implementation example of part A of FIG. 10; and

FIG. 14 is a flowchart showing another implementation example of part B of FIG. 10.

### DETAILED DESCRIPTION

Throughout the specification, when a component is described as “including” a particular element or group of elements, it is to be understood that the component is formed of only the element or the group of elements, or the element or group of elements may be combined with additional elements to form the component, unless the context clearly and/or explicitly describes the contrary. Further, phrases such as at least one of A and B, or at least one of A or B, can comprise A and B, or A or B.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

As used herein, components described as being “electrically connected” are configured such that an electrical signal can be transferred from one component to the other (although such electrical signal may be attenuated in strength as it is transferred and may be selectively transferred).

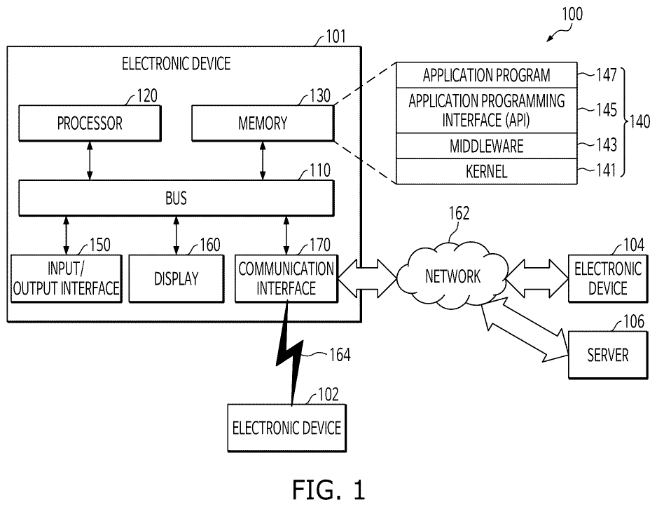

Hereinafter, various embodiments of the present disclosure will be described with reference to FIGS. 1 to 14. Throughout the specification, the same reference numerals may refer to the same components.

An electronic device according to various embodiments of the present disclosure may include, for example, at least one of a smartphone, a tablet PC, a mobile phone, a video phone, an e-book reader, a desktop PC, a laptop PC, a netbook computer, a workstation, a server, a PDA, a portable multimedia player (PMP), an MP3 player, a medical device, a camera, and a wearable device. A wearable device may include at least one of an accessory-type (e.g., a watch, a ring, a bracelet, an anklet, a necklace, glasses, contact lenses, or a head-mounted device (HMD), a fabric-or clothing-integrated type (e.g., an electronic garment), a body-attached type (e.g., a skin pad or tattoo), and an implantable circuit. In some embodiments, the electronic device may include at least one of, for example, a television, a digital video disk (DVD) player, an audio system, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, and an electronic picture frame.

In another embodiment, the electronic device may include at least one of various medical devices (e.g., various portable medical measuring devices (a blood sugar meter, a heart rate meter, a blood pressure meter, or a body temperature meter), magnetic resonance angiography (MRA), magnetic resonance imaging (MRI), computed tomography (CT), a camera, or an ultrasound machine), a navigation device, a global navigation satellite system (GNSS), an event data recorder (EDR), a flight data recorder (FDR), an automobile infotainment device, electronic equipment for ships (e.g., a navigation device for ships, a gyrocompass, or the like), avionics, a security device, a head unit for vehicles, an industrial or household robot, a drone, an ATM of a financial institution, a point of sales (POS) of a store, and an Internet of Things (IoT) device (e.g., a light bulb, various sensors, a sprinkler device, a fire alarm, a thermostat, a streetlight, a toaster, exercise equipment, a hot water tank, a heater, a boiler, or the like). According to some embodiments, the electronic device may include at least one of a piece of furniture, a part of a building/structure, a vehicle, an electronic board, an electronic signature receiving device, a projector, and various measuring devices (e.g., a water, electricity, gas or radio wave measuring device, etc.). In various embodiments, the electronic device may be a combination of two or more of the various devices described above. The electronic device according to the embodiment of the present disclosure is not limited to the devices described above.

FIG. 1 is a diagram illustrating an example of a network environment 100 including an electronic device 101 according to one embodiment of the present disclosure.

Referring to FIG. 1, the electronic device 101 may include a bus 110, a processor 120, a memory 130, an input/output interface 150, a display 160, and a communication interface 170.

The bus 110 may include a circuit that connects components (e.g., 120 to 170) to each other and transmits information (e.g., control messages or data) between the components.

The processor 120 may include one or more of a central processing unit, an application processor (AP), and a communication processor (CP). The processor 120 may execute or perform calculations, operations, or data processing to control and/or manage communication of at least one of the other components of the electronic device 101.

The memory 130 may include volatile and/or non-volatile memories. The memory 130 may store instructions and/or data associated with at least one of the other components of the electronic device 101. For example, the memory 130 may store instructions associated with the processor 120 (e.g., an application processor and/or a communication processor, etc.), and the processor 120 may execute the instructions stored in the memory 130. According to embodiments, the memory 130 may store software and/or programs 140.

The program 140 may include, for example, a kernel 141, middleware 143, an application programming interface (API)) 145, and/or an application program (or application) 147. At least a part of the kernel 141, the middleware 143, or the API 145 may be referred to as an operating system. The kernel 141 may control or manage system resources (e.g., a bus 110, a processor 120, or memory 130) used to execute operations or functions implemented in other programs (e.g., middleware 143, API 145, or application programs 147). Additionally, the kernel 141 may provide an interface that allows control or management of system resources by accessing individual components of the electronic device 101 from the middleware 143, the API 145, or the application program 147.

The middleware 143 may act as an intermediary to enable, for example, an API 145 or an application program 147 to communicate with the kernel 141 and exchange data. Additionally, the middleware 143 may process one or more task requests received from the application program 147 according to priority. For example, the middleware 143 may give priority to at least one of the application programs 147 to use a system resource (e.g., a bus 110, a processor 120, or a memory 130) of the electronic device 101 and process one or more of the task requests. The API 145 is an interface for an application program 147 to control functions provided by the kernel 141 or the middleware 143, and may include at least one interface or function (e.g., command) for file control, window control, image processing, or character control.

The input/output interface 150 may, for example, transmit commands or data, which are input from a user or another external device, to other components of the electronic device 101, or may output commands or data, which are received from other components of the electronic device 101, to the user or another external device.

The display 160 may include, for example, a liquid crystal display (LCD), a light emitting diode (LED) display, an organic light emitting diode (OLED) display, a micro electro mechanical systems (MEMS) display, or an electronic paper display. The display 160 may, for example, display various contents (e.g., text, images, videos, icons, and/or symbols, etc.) to the user. The display 160 may include a touch screen and may receive touch, gesture, proximity or hovering inputs using, for example, an electronic pen or a part of the user's body.

The communication interface 170 may establish communication between, for example, the electronic device 101 and an external device (e.g., a first external electronic device 102, a second external electronic device 104, or a server 106). For example, the communication interface 170 may be connected to a network 162 via wireless or wired connection to communicate with an external device (e.g., the second external electronic device 104 or the server 106). In some embodiments, the communication interface 170 may transmit packets. According to one embodiment, the communication interface 170 may transmit packets according to the final target transmission power determined by the processor 120.

The wireless communication may include, for example, at least one of cellular communication using at least one of LTE, LTE Advance (LTE-A), code division multiple access (CDMA), wideband CDMA (WCDMA), universal mobile telecommunications system (UMTS), Wireless Broadband (WiBro), and global system for mobile communications (GSM), a wireless local area network (WLAN) (e.g., WiFi), Bluetooth, Bluetooth Low Energy (BLE), Zigbee, near field communication (NFC), magnetic secure transmission, radio frequency (RF), and a body area network (BAN). In one embodiment, the wireless communication may include a global navigation satellite system (GNSS). GNSS may be, for example, Global Positioning System (GPS), Global Navigation Satellite System (Glonass), Beidou Navigation Satellite System (hereinafter, “Beidou”) or Galileo, the European global satellite-based navigation system. Hereinafter, in the present disclosure, “GPS” may be used interchangeably with “GNSS”. Wired communication may include at least one of, for example, universal serial bus (USB), high-definition multimedia interface (HDMI), recommended standard 232(RS-232 ), power line communication, and plain old telephone service (POTS). A network 162 may include at least one of a telecommunications network, for example, a computer network (e.g., a LAN or WAN), the Internet, and a telephone network.

The first and second external electronic devices 102 and 104 may be the same type of device as the electronic device 101 or a different type of device from the electronic device 101. In some embodiments, all or part of the operations executed by the electronic device 101 may be executed by a single electronic device or a plurality of electronic devices (e.g., electronic devices 102 and 104 or a server 106). According to one embodiment, when the electronic device 101 performs a certain function or service automatically or upon request, the electronic device 101 may execute the functions or services by itself, or may transmit a request to other devices (e.g., the electronic devices 102 and 104 or the server 106) to perform a part of the functions. Another electronic device (e.g., electronic devices 102 and 104 or a server 106) may execute the requested function or additional function and transmit the result to the electronic device 101. The electronic device 101 may process the received result and/or may provide the requested function or service. In some embodiments, cloud computing, distributed computing or client-server computing technologies may be used.

FIG. 1 illustrates components of the electronic device 101, and illustrates the function of the components of the electronic device 101. However, FIG. 1 is not intended to be limiting.

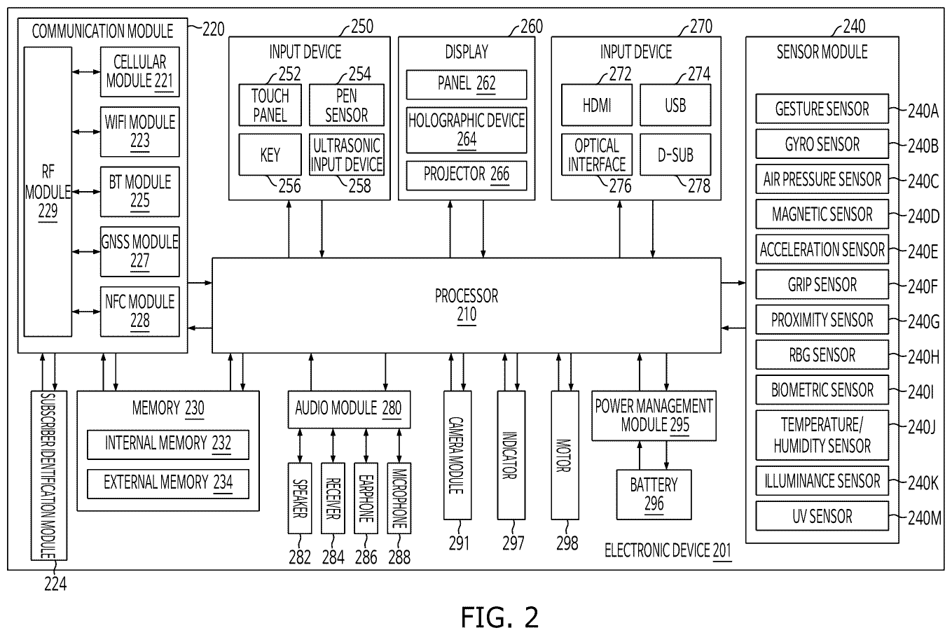

FIG. 2 is a block diagram illustrating an example of an electronic device 201 according to one embodiment of the present disclosure. The electronic device 201 may include, for example, all or part of the electronic device 101 illustrated in FIG. 1.

Referring to FIG. 2, the electronic device 201 may include one or more processors (e.g., processor 210), a communication module 220, a subscriber identification module 224, a memory 230, a sensor module 240, an input device 250, a display 260, an interface or input device 270, an audio module 280, a camera module 291, a power management module 295, a battery 296, an indicator 297, and a motor 298.

The processor 210 may control a number of hardware or software components connected to the processor 210 by driving an operating system or application program, and may perform various data processing functions and operations. In some embodiments, the processor 210 may be implemented as a system on chip (SoC). According to one embodiment, the processor 210 may further include a graphic processing unit (GPU) and/or an image signal processor. In some embodiments, the processor 210 may include at least some of the components illustrated in FIG. 2, and/or at least a part of the processor 210 may be included in at least some of the components illustrated in FIG. 2. The processor 210 may load and process commands or data received from at least one of other components (e.g., non-volatile memory, etc.) into a volatile memory, and store result data in a non-volatile memory.

The communication module 220 may establish a direct (e.g., wired) communication channel or wireless communication channel between the electronic device 201 and an external electronic device, and may communicate through the established communication channel. The communication module 220 may operate independently of at least a part of the processor 210, and may include one or more communication processors that support direct (e.g., wired) communication or wireless communication. According to one embodiment, the communication module 220 may include a wireless communication module (e.g., a cellular module 221), a WiFi module 223, a Bluetooth module 225, a GNSS module 227, an NFC module 228, an RF module 229, etc.) and/or a wired communication module (e.g., a local area network (LAN), a communication module, a power line communication module, etc.). The various types of communication modules may be integrated into a single component (e.g., a single chip) or implemented as a plurality of separate components (e.g., a plurality of chips).

The cellular module 221 may provide, for example, voice calls, video calls, text services, or Internet services through a communication network. According to one embodiment, the cellular module 221 may use a subscriber identity module (e.g., a SIM card 224) to distinguish and authenticate the electronic device 201 within a communication network.

According to one embodiment, the cellular module 221 may perform at least some of the functions provided by the processor 210. In one embodiment, the cellular module 221 may include a communications processor. In some embodiments, at least some (e.g., two or more) of the cellular module 221, the WiFi module 223, the Bluetooth module 225, the GNSS module 227, and the NFC module 228 may be included within a single integrated chip (IC) or an IC package. The RF module 229 may, for example, transmit and receive communication signals (e.g., RF signals). The RF module 229 may include, for example, a transceiver, a power amp module (PAM), a frequency filter, a low noise amplifier (LNA), or an antenna. In another embodiment, at least one of the cellular module 221, the WiFi module 223, the Bluetooth module 225, the GNSS module 227, and the NFC module 228 may transmit and receive RF signals through a separate RF module.

The subscriber identification module 224 may include, for example, a card or embedded SIM including a subscriber identification module and may include unique identification information (e.g., an integrated circuit card identifier (ICCID) or subscriber information (e.g., an international mobile subscriber identity (IMSI)).

The memory 230 (e.g., memory 130) may include, for example, a built-in memory 232 or an external memory 234. The built-in memory 232 may include, for example, at least one of a volatile memory (e.g., DRAM, SRAM, or SDRAM) and a non-volatile memory (e.g., one-time programmable ROM (OTPROM), PROM, EPROM, EEPROM, mask ROM, flash ROM, flash memory, a hard drive, or a solid state drive SSD). The external memory 234 may include a flash drive, for example, compact flash (CF), secure digital (SD), Micro-SD, Mini-SD, extreme digital (xD), multi-media card (MMC), or memory stick. The external memory 234 may be functionally or physically connected to the electronic device 201 through various interfaces.

The sensor module 240 may, for example, measure a physical quantity or detect the operating status of an electronic device 201 and convert the measured or detected information into an electrical signal. In some embodiments, the sensor module 240 may detect an event for the electronic device 201. An event may be an event (e.g., a human body proximity state change event, etc.) that affects the power absorbed by the user among the power which is output from the electronic device 201. The sensor module 240 may include, for example, at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., a red, green, blue (RGB) sensor), a biometric sensor 240I, a temperature/humidity sensor 240J, an illuminance sensor 240K, and an ultra violet (UV) sensor 240M. Additionally, or alternatively, the sensor module 240 may include, for example, an olfactory (e-nose) sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors. In some embodiments, the electronic device 201 further includes a processor configured to control the sensor module 240, wherein the processor is a part of the processor 210. Alternatively, the electronic device 201 may include a processor that is separate from the processor 210, such that the processor can separately control the sensor module 240 while the processor 210 is in a sleep mode.

The input device 250 may include, for example, a touch panel 252, a (digital) pen sensor 254, a key 256, or an ultrasonic input device 258. The touch panel 252 may use, for example, at least one of electrostatic, pressure-sensitive, infrared, or ultrasonic methods. Additionally, the touch panel 252 may further include a control circuit. The touch panel 252 may further include a tactile layer to provide a tactile response to the user. The (digital) pen sensor 254 may be, for example, part of the touch panel or may include a separate recognition sheet. The key 256 may include, for example, a physical button, an optical key or a keypad. The ultrasonic input device 258 may detect ultrasonic waves generated from an input tool through a microphone (e.g., a microphone 288) and confirm data corresponding to the detected ultrasonic waves.

A display 260 (e.g., a display 160) may include a panel 262, a holographic device 264, a projector 266, and/or a control circuit for controlling them. The panel 262 may be flexible, transparent or wearable. The panel 262 may be composed of a touch panel 252 and one or more modules. According to one embodiment, the panel 262 may include a pressure sensor (or force sensor) capable of measuring the intensity of pressure applied to a user's touch. The pressure sensor may be implemented integrally with the touch panel 252 or as one or more sensors separate from the touch panel 252. The holographic device 264 may display a three-dimensional image in the air by using interference of light. The projector 266 may display an image by projecting light onto a screen. The screen may be located, for example, inside or outside the electronic device 201.

The interface 270 may include, for example, HDMI 272, USB 274, an optical interface 276, or D-subminiature (D-sub) 278. The interface 270 may be included, for example, in the communication interface 170 illustrated in FIG. 1. Additionally, or alternatively, the interface 270 may include, for example, a mobile high-definition link (MHL) interface, an SD card/multi-media card (MMC) interface, or an infrared data association (IrDA) standard interface.

The audio module 280 may, for example, bidirectionally convert sound into electrical signals and may convert electrical signals into sounds. At least some components of the audio module 280 may be included in the input/output interface 150 illustrated in FIG. 1. The audio module 280 may process sound information which is input or output through, for example, a speaker 282, a receiver 284, earphones 286, or a microphone 288.

The camera module 291 is, for example, a device capable of capturing still images and moving images, and according to one embodiment, may include one or more image sensors (e.g., a front sensor or a rear sensor), a lens, an image signal processor (ISP), or a flash (e.g., an LED or xenon lamp, etc.).

The power management module 295 may, for example, manage the power of the electronic device 201. According to one embodiment, the power management module 295 may include a power management integrated circuit (PMIC), a charging IC, or a battery or fuel gauge. PMIC may have wired and/or wireless charging modes. The wireless charging method may include, for example, a magnetic resonance method, a magnetic induction method, or an electromagnetic wave method, and may further include additional circuits for wireless charging, for example, a coil loop, a resonant circuit, or a rectifier. A battery gauge may measure, for example, the remaining capacity of a battery 296, voltage, current, or temperature during charging. The battery 296 may include, for example, a rechargeable battery and/or a solar cell.

An indicator 297 may indicate a specific status of the electronic device 201 or a part thereof (e.g., a processor 210), for example, a booting status, a message status, or a charging status. The motor 298 may convert electrical signals into mechanical vibrations and generate vibrations or haptic effects, etc.

The electronic device 201 may include a mobile TV support device (e.g., GPU) capable of processing media data according to standards such as digital multimedia broadcasting (DMB), digital video broadcasting (DVB), or mediaFlo.

Each of the components described in the present disclosure may be composed of one or more components, and the names of the components may vary depending on the type of electronic device. In various embodiments, the electronic device (e.g., the electronic device 201) may have some components omitted, may include additional components, or may have some of the components combined to form a single entity, but may perform the same functions of the corresponding components prior to combination.

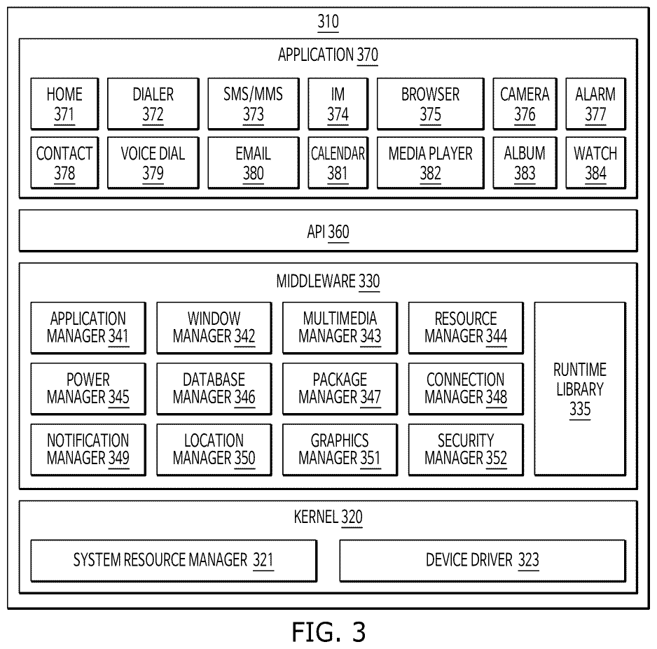

FIG. 3 is a block diagram illustrating an example of a program module according to one embodiment of the present disclosure. According to one embodiment, a program module 310 (e.g., a program 140) may include an operating system that controls resources related to an electronic device (e.g., an electronic device 101 of FIG. 1 and/or an electronic device 201 of FIG. 2) and/or various applications (e.g., application programs 147) running on the operating system.

Referring to FIG. 3, the program module 310 may include a kernel 320 (e.g., kernel 141), middleware 330 (e.g., middleware 143), API 360 (e.g., API 145) and/or application 370 (e.g., application program 147). At least a part of the program module 310 may be preloaded on the electronic device or may be downloadable from an external electronic device (e.g., electronic devices 102 and 104, a server 106, etc.).

The kernel 320 may include, for example, a system resource manager 321 and/or a device driver 323. The system resource manager 321 may control, allocate, or recover system resources. According to one embodiment, the system resource manager 321 may include a process management unit, a memory management unit, or a file system management unit. The device driver 323 may include, for example, a display driver, a camera driver, a Bluetooth driver, a shared memory driver, a USB driver, a keypad driver, a WiFi driver, an audio driver, or an inter-process communication (IPC) driver. The middleware 330 may, for example, provide functions commonly required by the applications 370 or provide various functions to the applications 370 through APIs 360 so that the applications 370 may use limited system resources within an electronic device. According to one embodiment, the middleware 330 may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphics manager 351, and a security manager 352.

The runtime library 335 may include, for example, library modules used by a compiler to add new functionality via a programming language while the application 370 is running. The runtime library 335 may perform input/output management, memory management, or arithmetic function processing. The application manager 341 may, for example, manage the life cycle of an application 370. The window manager 342 may manage the graphical user interface (GUI) resources used on the screen. The multimedia manager 343 may identify the format required for playing media files and perform encoding or decoding of the media files using a codec suitable for the format. The resource manager 344 may manage the source code or memory space of the application 370. The power manager 345 may, for example, manage the capacity or power of a battery and provide power information necessary for the operation of an electronic device. In one embodiment, the power manager 345 may interact with a basic input/output system (BIOS). A database manager 346 can, for example, create, retrieve, or modify a database to be used in an application 370. The package manager 347 may manage the installation or renewal of applications distributed in the form of package files.

The connection manager 348 may, for example, manage wireless connections. The notification manager 349 may provide the user with events such as arrival messages, appointments, and proximity notifications. The location manager 350 may, for example, manage location information of an electronic device. The graphics manager 351 may, for example, manage graphic effects to be provided to the user or a user interface related thereto. The security manager 352 may provide, for example, system security or user authentication. According to one embodiment, the middleware 330 may include a telephony manager for managing voice or video calling functionality of the electronic device or a middleware module that may form a combination of the functions of the aforementioned components. According to one embodiment, the middleware 330 may provide modules specialized for each type of operating system. The middleware 330 may dynamically delete some existing components or add new components. The API 360 is, for example, a set of API programming functions and may be provided in different configurations depending on the operating system. For example, for Android or iOS, one set of APIs may be provided per platform, and for Tizen, two or more sets of APIs may be provided per platform.

The application 370 may include, for example, a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, a watch 384, a health care (e.g., measuring the amount of exercise or blood sugar, etc.) or environmental information (e.g., information on barometric pressure, humidity, or temperature) providing application. According to one embodiment, the application 370 may include an information exchange application capable of supporting information exchange between the electronic device and an external electronic device. The information exchange application may include, for example, a notification relay application for conveying certain information to an external electronic device or a device management application for managing an external electronic device. For example, the notification delivery application may deliver notification information, which is generated from another application of the electronic device, to an external electronic device, or may receive notification information from the external electronic device and provide the received information to the user. A device management application may, for example, control the functions of an external electronic device that communicates with the electronic device (e.g., turn-on/turn-off of the external electronic device itself (or some of its components) or adjustment of the brightness (or resolution) of the display), or install, uninstall, or update applications that run on the external electronic device. According to one embodiment, the application 370 may include an application specified based on a property of the external electronic device (e.g., a health management application of a mobile medical device). According to one embodiment, the application 370 may include an application received from an external electronic device. At least a part of the program module 310 may be implemented (e.g., executed) in software, firmware, hardware (e.g., a processor 210), or a combination of at least two or more of these, and may include modules, programs, routines, instruction sets, or processes for performing one or more functions.

The term “module” used in this disclosure includes a unit composed of hardware, software or firmware, and may be used interchangeably with terms such as logic, logic block, component or circuit. The “module” may be a component that is composed of an integral part or a minimum unit that performs one or more functions or a part thereof. The “module” may be implemented mechanically or electronically and may include, for example, an application-specific integrated circuit (ASIC) chip, field-programmable gate arrays (FPGAs) or other programmable logic device, known or to be developed in the future, that performs certain operations. At least a part of a device (e.g., modules or functions thereof) or a method (e.g., operations) according to various embodiments may be implemented as instructions stored in a computer-readable storage medium (e.g., memory 130) in the form of a program module. When an instruction is executed by a processor (e.g., processor 120), the processor may perform a function corresponding to the instruction. The computer-readable recording medium may be a tangible, non-transitory medium, such as a hard disk, a floppy disk, a magnetic medium (e.g., a magnetic tape), an optical recording medium (e.g., a CD-ROM and a DVD), a magneto-optical medium (e.g., a floptical disk), a built-in memory, etc. Instructions may contain code generated by a compiler or code that may be executed by an interpreter. Modules or program modules according to various embodiments may include at least one or more of the above-described components, some of which may be omitted, or may further include other components. According to various embodiments, operations performed by a module, program module or other component may be executed sequentially, in parallel, iteratively or heuristically, or at least some of the operations may be executed in a different order or omitted, or other operations may be added.

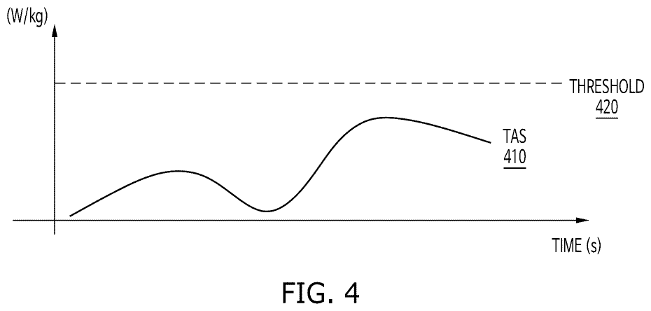

FIG. 4 is a diagram showing an example of a time-specific absorption rate (SAR) graph according to one embodiment of the present disclosure. Electronic devices may radiate electromagnetic waves for wireless communication. Some of the electromagnetic waves emitted by electronic devices may be absorbed by the user of the electronic device. Specific Absorption Rate (SAR) represents the amount of emitted electromagnetic waves from the electronic device that are absorbed by the user's biological tissue. An electronic device may be designed to monitor a specific absorption rate (SAR) associated with a wireless communication and to control the transmission power of the wireless communication so that the intensity of the radiated electromagnetic waves is unlikely to cause harm to the user. The specific absorption rate (SAR) associated with a wireless communication may be calculated based on, for example, the transmission power and size (capacity) of the signal/data transmitted through the wireless communication, and the proximity status of the electronic device to the human body. In one embodiment, the monitored specific absorption rate (SAR) may be a time-averaged SAR (TAS) 410.

To control the transmission power of the wireless communication in relation to the specific absorption rate (SAR), the electronic device may control the transmission power. For example, the electronic device may adjust the transmission power downwardly (e.g., by reducing the transmission power) when the time-averaged SAR (TAS) 410 approaches a threshold 420. Additionally, or alternatively, the electronic device may adjust the transmission power upwardly (e.g., by increasing the transmission power) when the time-averaged SAR (TAS) 410 moves away from the threshold 420 and/or is predetermined amount below the threshold 420.

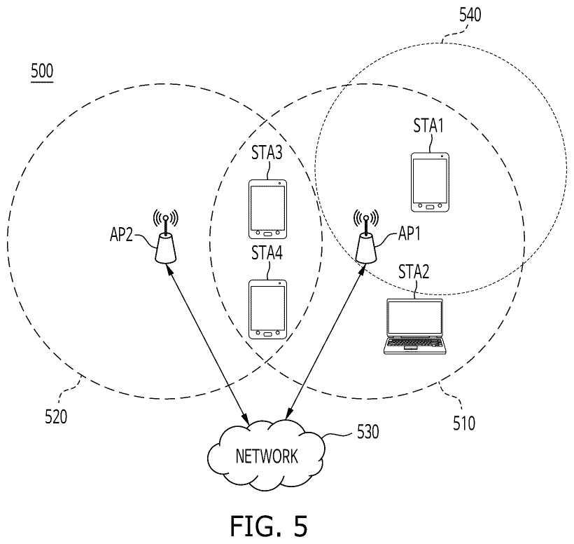

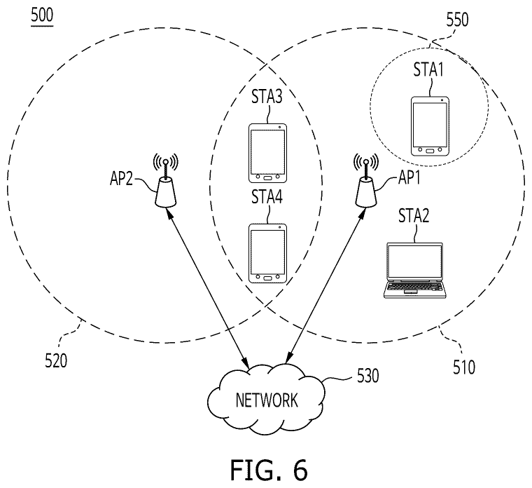

FIG. 5 and FIG. 6 illustrate a wireless communication system 500 according to one embodiment of the present disclosure. Specifically, FIGS. 5 and 6 illustrate a wireless local area network (WLAN) system as an example of the wireless communication system 500. Hereinafter, when describing embodiments of the present disclosure, a WLAN system will be described relative to the wireless communication system 500. However, the present disclosure may be applied to other communication systems having a similar technical background, for example, with the wireless communication system 500 instead comprising cellular communication systems such as long term evolution (LTE), LTE-advanced (LTE-A), new radio (NR), wireless broadband (WiBro), global system for mobile communication (GSM), or short-range communication systems such as Bluetooth, near field communication (NFC) without significantly departing from the scope of the present disclosure.

Referring to FIGS. 5 and 6, the wireless communication system 500 may include one or more access points, for example, a first access point AP1 and a second access point AP2. The wireless communication system 500 may include one or more stations, for example, a first station STA1, a second station STA2, a third station STA3, and a fourth station STA4. The first and second access points AP1 and AP2 may connect to a network 530 including Internet, an internet protocol (IP) network, or any other network. The first access point AP1 may provide access to the network 530 to first to fourth stations STA1, STA2, STA3 and STA4 within a first coverage area 510. Additionally, the second access point AP2 may provide access to the network 530 to the third and fourth stations STA3 and STA4 within a second coverage area 520. In some embodiments, the first and second access points AP1 and AP2 may communicate with at least one of the first to fourth stations STA1, STA2, STA3 and STA4 based on wireless fidelity (WiFi) or any other WLAN access technology.

The access points AP1, AP2 may comprise a router, a gateway, etc., and the stations STA1, STA2, STA3 and STA4 may comprise a mobile station, a subscriber station, a terminal, a mobile terminal, a wireless terminal, user equipment, a user, etc. The stations STA1, STA2, STA3 and STA4 may be a portable device, such as a mobile phone, a laptop computer, a wearable device, etc., or a stationary device, such as a desktop computer, a smart TV, etc.

The first station STA1 may establish a wireless communication connection with the first access point AP1 to facilitate data transfer between the first station STA1 and the first access point AP1. In some embodiments of the present disclosure, the first station STA1 may be referred to as an electronic device, and the first access point AP1 may be referred to as an external electronic device.

The first station STA1 may control the transmission power of the wireless communication associated with the specific absorption rate (SAR). As a result, the transmission coverage of the first station STA1 may be changed depending on the transmission power of the wireless communication. For example, when the transmission power of the first station STA1 is set to a first transmission power, the transmission coverage 540 of the first station STA1 may reach the first access point AP1 as shown in FIG. 5, and the wireless communication connection between the first station STA1 and the access point AP1 is maintainable. However, when the transmission power of the first station STA1 is reduced to a second transmission power that is lower than the first transmission power, the transmission coverage 550 of the first station STA1 may not reach the first access point AP1 as shown in FIG. 6, and thus, the wireless communication connection between the first station STA1 and the access point AP1 may be disconnected and is not maintainable. If the transmission power of the first station STA1 is controlled by considering only the specific absorption rate (SAR) without considering the wireless communication connection between the first station STA1 and the access point AP1, there is a risk that the wireless communication connection between the first station STA1 and the access point AP1 will be disconnected and is not maintainable. This is due, at least in part, to the transmission power of the first station STA being reduced to the second transmission power, and the transmission coverage 550 not reaching the first access point AP1. An inability to maintain the wireless communication connection between the first station STA1 and the access point AP1 may negatively impact user experience and communication quality. To address these issues, the first station STA1 (i.e., an electronic device) according to various embodiments of the present disclosure may manage the specific absorption rate (SAR) while maintaining a wireless communication connection. This will be described in more detail below.

The description herein may be focused on the wireless communication connection between the first station STA1 and the first access point AP1. However, it will be understood that the embodiments of the present disclosure may be performed in a similar, or identical, manner in the other wireless communication devices STA2 to STA4, and the access points AP1 and AP2 within the wireless communication system 500.

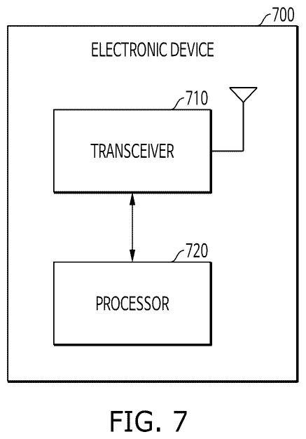

FIG. 7 is a block diagram illustrating an example of an electronic device 700 according to one embodiment of the present disclosure. Referring to FIG. 7, the electronic device 700 may include a transceiver 710 and a processor 720. In some embodiments, the transceiver 710 and the processor 720 may be contained in a single package or may be contained in different packages.

The processor 720 may obtain specific absorption rate (SAR) information associated with electromagnetic waves generated by the electronic device 700. The processor 720 may manage the specific absorption rate (SAR) of the electronic device 700 while maintaining a wireless communication connection between the electronic device 700 and an external electronic device. For example, the processor 720 may adjust at least one of the transmission power and the transmission speed of the wireless communication based on the specific absorption rate (SAR) and based on whether the wireless communication connection between the electronic device 700 and the external electronic device is maintainable. For example, when determining whether the wireless communication connection is maintainable, the processor 720 may determine whether the wireless communication would be maintained, or is capable of being maintained, if the transmission power is changed from a current transmission power to a different transmission power (e.g., a target transmission power, for example). The transmission speed of the wireless communication comprises the data rate at which the electronic device 700 sends and receives data to/from the external electronic device (e.g., through the wireless network) and may be measured in bits per second (bps). The transmission power of the wireless communication comprises the strength of the radio signal emitted by the electronic device 700 when a wireless communication connection is established with the external electronic device, and may be measured in milliwatts (mW) or decibels relative to 1 milliwatt (dBm).

As an example, the processor 720 may first determine an initial target transmission power based on the specific absorption rate (SAR) information. As described below, the initial target transmission power may be determined based on a comparison of the specific absorption rate to a threshold. In one embodiment, if the initial target transmission power is less than the current transmission power, the processor 720 may determine whether the wireless communication connection is maintainable at the initial target transmit power. If it is determined that the wireless communication connection is not maintainable if the wireless communication is at the initial target transmission power, the processor 720 may adjust the transmission speed of the wireless communication without adjusting the transmission power, or adjust the transmission power to the minimum transmission power for maintaining the wireless communication connection and additionally adjust the transmission speed. The minimum transmission power may comprise the power at which the wireless communication connection is maintainable, but, at a power below the minimum transmission power, the wireless communication connection is not maintainable. As such, the minimum transmission power is a lower power limit at which the wireless communication connection is maintainable. In one embodiment, if the initial target transmission power is greater than or equal to the current transmission power, the processor 720 may adjust the transmission power to the minimum transmission power for maintaining the wireless communication connection in order to manage the specific absorption rate (SAR) budget. This will be described in more detail below.

The transceiver 710 may transmit and receive signals/data with an external electronic device (e.g., an access point, etc.) via wireless communication. For example, the transceiver 710 may transmit signals/data to the external electronic device according to a transmission power and/or transmission speed determined by the processor 720.

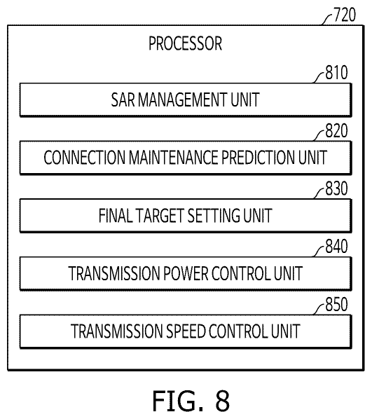

FIG. 8 is a block diagram showing an example of the internal configuration of a processor 720 according to one embodiment of the present disclosure. For convenience of explanation in FIG. 8, the internal configurations of the processor 720 are illustrated as being functionally separated, but the separated configurations are not intended to be limited to physical separation. In addition, FIG. 8 does not illustrate all of the internal configurations of the processor 720, and illustrates only some configurations, and some configurations may be added, changed, or omitted. Additionally, in FIG. 8, the processor 720 is illustrated as a single processor 720, but this is only for convenience of explanation and the embodiment is not limited to this example. For example, the processor 720 may include a plurality of processors 720, and at least one internal component may be included in a different processor 720.

According to one embodiment, the processor 720 may include a specific absorption rate (SAR) management unit 810, a connection maintenance prediction unit 820, a final target setting unit 830, a transmission power control unit 840, and a transmission speed control unit 850.

The SAR management unit 810 may obtain SAR information related to electromagnetic waves generated from the electronic device 700. According to one embodiment, the SAR information may include information related to a time-averaged SAR (TAS) over a predefined time interval according to wireless communication.

For example, the SAR management unit 810 may receive SAR information according to a wireless communication from other components of the electronic device 700. Additionally, or alternatively, the SAR management unit 810 may calculate SAR (e.g., time-averaged SAR (TAS)) according to a wireless communication. The specific absorption rate (SAR) according to the wireless communication may be calculated based on the transmission power and size or capacity of the signal/data transmitted through the wireless communication, and the proximity status of the electronic device 700 to the human body.

The SAR management unit 810 may determine the initial target transmission power based on the acquired SAR information. For example, if the time-averaged SAR (TAS) approaches a threshold, the SAR management unit 810 may select a power that is lower than the current transmission power as the initial target transmission power. As another example, if the time-averaged SAR (TAS) is moving away from the threshold and is less than the threshold, the SAR management unit 810 may select a power that is higher than the current transmission power as the initial target transmission power.

The connection maintenance prediction unit 820 may determine whether a wireless communication connection is maintainable at an initial target transmission power or a transmission power within a range associated with the initial target transmission power. The range associated with the initial target transmission power may comprise a set of transmission power values that will maintain the wireless communication connection, with the lowest transmission power value in the range comprising the minimum transmission power that maintains the wireless communication connection. For example, if the initial target transmission power is less than the current transmission power, the connection maintenance prediction unit 820 may determine whether the wireless communication connection is maintainable at the initial target transmission power. As another example, if the initial target transmission power is greater than or equal to the current transmission power, the connection maintenance prediction unit 820 may determine whether the wireless communication connection is maintainable at a transmission power less than the initial target transmission power. As another example, the connection maintenance prediction unit 820 may determine whether a wireless communication connection is maintainable at a transmission power equal to or less than the initial target transmission power.

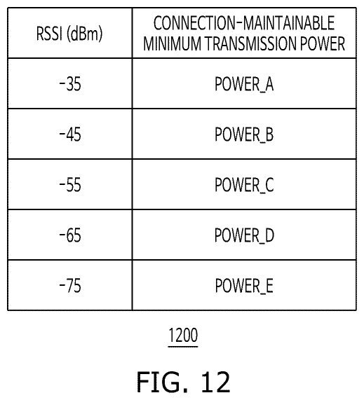

According to one embodiment, the connection maintenance prediction unit 820 may determine the minimum transmission power that will maintain a wireless communication connection based on status information of a signal received by the electronic device 700 via wireless communication. The connection maintenance prediction unit 820 may determine whether the wireless communication connection is maintainable at an initial target transmission power or a transmission power within a range associated with the initial target transmission power based on the minimum transmission power capable of maintaining the wireless communication connection. In this regard, more detailed description is provided below with reference to FIG. 12.

The final target setting unit 830 may determine the final target transmission power and/or target transmission speed based on determinations made by the connection maintenance prediction unit 820. For example, if the connection maintenance prediction unit 820 determines that the wireless communication connection is not maintainable at the initial target transmission power, the final target setting unit 830 may determine a transmission speed that may have the same Specific absorption rate (SAR) gain as the initial target transmission power as the target transmission speed. For example, in response to determining that the wireless communication connection is not maintainable at the initial target transmission power, the final target setting unit 830 may determine the target transmission speed of the wireless communication that would result in a SAR gain equal to a SAR gain that would have resulted from the initial target transmission power without adjusting the transmission speed. The SAR gain comprises the change in SAR between an initial, time-averaged SAR (TAS) to an adjusted target SAR. In addition, or in the alternative, if the connection maintenance prediction unit 820 determines that the wireless communication connection is not maintainable at the initial target transmission power, the final target setting unit 830 may determine the minimum transmission power that will maintain the wireless communication connection. The final target setting unit 830 may set the minimum transmission power as the final target transmission power, and may determine the transmission speed. The transmission speed may be determined based on the transmission speed and the final target transmission power having the same SAR gain as an SAR gain at the initial target transmission power. For example, if the time-averaged SAR (TAS) approaches or exceeds the threshold, then a reduced, target SAR will be determined, wherein the reduced, target SAR may be below the threshold. However, due to the wireless communication connection not being maintained at the initial target transmission power, the final target setting unit 830 may determine the minimum transmission power, which is different than the initial target transmission power, at which the wireless communication connection is maintainable, and may set the minimum transmission power as the final target transmission power. To accommodate for the difference between the minimum transmission power and the initial target transmission power, the final target setting unit 830 may also adjust a transmission speed, for example, by selecting a target transmission speed. The target transmission speed is selected such that the final target transmission power (e.g., equal to the minimum transmission power) and the target transmission speed selected by the final target setting unit 830 may produce the target SAR. Accordingly, the target transmission speed and the final target transmission power may be calculated such that the target transmission speed and the final target transmission power result in a SAR gain that is equal to a SAR gain that would have resulted from the initial target transmission power without adjusting a transmission speed. As another example, if the connection maintenance prediction unit 820 determines that the wireless communication connection is maintainable at the initial target transmission power, the final target setting unit 830 may set the initial target transmission power as the final target transmission power.

The transmission power control unit 840 may adjust the transmission power used by the electronic device 700 to transmit a wireless communication signal according to the final target transmission power which is set by the final target setting unit 830. According to one embodiment, the transmission power control unit 840 may adjust the transmission power of wireless communication to the final target transmission power by adjusting the transmission power stepwise or continuously.

The transmission speed control unit 850 may adjust the transmission speed used by the electronic device 700 to transmit a wireless communication signal according to the target transmission speed that is set by the final target setting unit 830.

The transmission power control unit 840 and the transmission speed control unit 850 may adjust the transmission power and the transmission speed, respectively. This adjustment may comprise controlling other components of the electronic device 700 (e.g., a transceiver, a communication module, a communication interface, etc.) to facilitate adjustment of the transmission power and the transmission speed.

Referring to FIG. 8, the operation method of the electronic device is described above focusing on the role and function of each internal component of the processor, and hereinafter, the operation method of the electronic device for managing the specific absorption rate (SAR) is described in more detail.

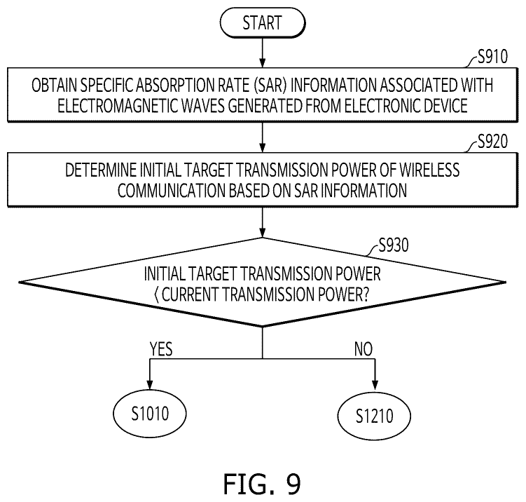

FIGS. 9 to 11 are flowcharts illustrating an example of an operation method of an electronic device for managing specific absorption rate (SAR) according to one embodiment of the present disclosure. According to one embodiment, the method may be performed by a processor (e.g., at least one processor of an electronic device). The processor may adjust at least one of a transmission power and a transmission speed used to transmit a wireless communication signal based on the specific absorption rate (SAR) information.

Referring to FIG. 9, the processor may obtain specific absorption rate (SAR) information associated with electromagnetic waves generated from the electronic device 700 (S910). According to one embodiment, the SAR information may include information about a time-averaged SAR (TAS) over a predefined time interval according to wireless communication. Additionally, the processor may determine the initial target transmission power of wireless communication based on the SAR information (S920). The initial target transmission power may be determined based on a comparison of the specific absorption rate to a threshold. For example, if the time-averaged SAR (TAS) approaches or exceeds the threshold, then a reduced, target SAR will be determined, wherein the reduced, target SAR may be below the threshold. The initial target transmission power may be the transmission power that can achieve the reduced, target SAR without adjusting or changing the transmission speed.

If the initial target transmission power is less than the current transmission power (YES in S930), step S1010 may be performed, and if the initial target transmission power is greater than or equal to the current transmission power (NO in S930), step S1210 may be performed.

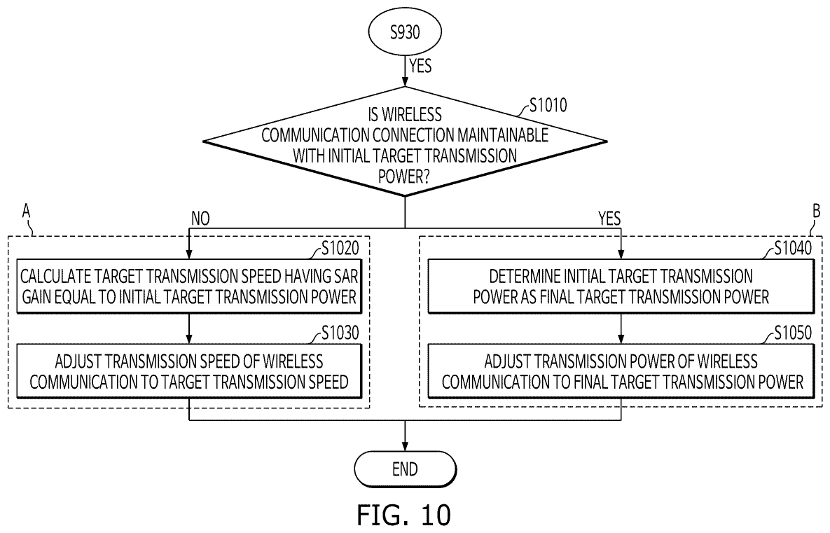

Referring to FIG. 10, if the initial target transmission power is less than the current transmission power (YES in S930), the processor may determine whether the wireless communication connection is maintainable at the initial target transmission power (S1010). According to one embodiment, the processor determines a minimum transmission power capable of maintaining the wireless communication connection based on status information of a signal received by the electronic device 700 via wireless communication. The processor may then determine whether the initial target transmission power is equal to or greater than the minimum transmission power, thereby determining whether the wireless communication connection is maintainable at the initial target transmission power. In this regard, more detailed description is provided below with reference to FIG. 12.

In one embodiment, in response to determining that the wireless communication connection is not maintainable at the initial target transmission power (NO in S1010), the processor may calculate a target transmission speed having a SAR gain equal to a SAR gain at the initial target transmission power (S1020). The target transmission speed having the same SAR gain as the SAR gain at initial target transmission power may mean that when the transmission speed is adjusted to the corresponding target transmission speed, a SAR reduction is achieved, and this SAR reduction is the same as, or similar to, the SAR reduction that is achieved when the transmission power is adjusted to the initial target transmission power. Thereafter, the processor may adjust the transmission speed of the wireless communication to the target transmission speed (S1030). For example, the processor may control other components within the electronic device (e.g., a communications module, etc.) so that the transmission rate of the wireless communication becomes the target transmission speed. Accordingly, the required degree of SAR reduction may be achieved by reducing the transmission speed to the target transmission speed instead of adjusting the transmission power.

In one embodiment, in response to determining that the processor will maintain a wireless communication connection at the initial target transmission power (YES in S1010), the processor may set the initial target transmission power as the final target transmission power (S1040) and adjust the transmission power of the wireless communication to the final target transmission power (S1050). For example, the processor may control other components within the electronic device (e.g., a communications module, etc.) such that the transmission power of the wireless communication becomes the final target transmission power.

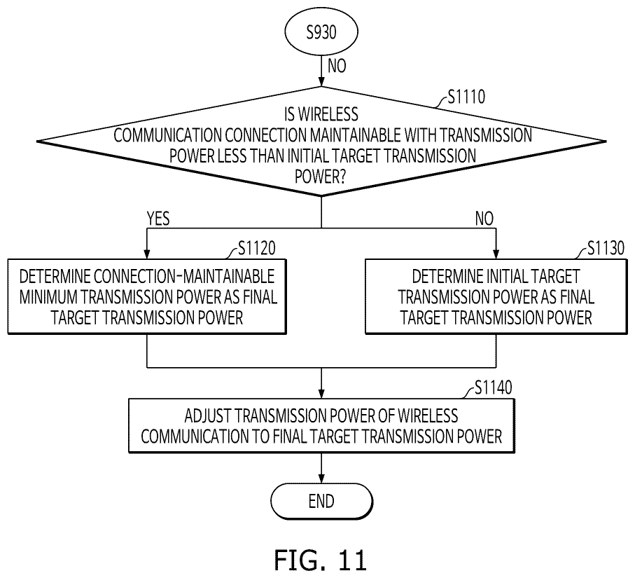

Referring to FIG. 11, if the initial target transmission power is greater than or equal to the current transmission power (NO in S930), the processor may determine whether the wireless communication connection is maintainable at a transmission power less than the initial target transmission power (S1110). According to one embodiment, the processor determines a minimum transmission power capable of maintaining the wireless communication connection based on status information of a signal received by the electronic device 700 via wireless communication, and determines whether the initial target transmission power exceeds the minimum transmission power, thereby determining whether the wireless communication connection is maintainable with a transmission power less than the initial target transmission power. Additional details are provided below with reference to FIG. 12.

In one embodiment, in response to determining that the wireless communication connection is maintainable with a transmission power less than the initial target transmission power (YES in S1110), the processor may set the minimum transmission power, at which the connection is maintainable, as the final target transmission power (S1120). Thereafter, the processor may adjust the transmission power of the wireless communication to the final target transmission power (S1140). In this case, the available SAR budget may be efficiently managed by reducing the transmission power as much as possible within a range at which the wireless communication connection is maintainable, even if the current SAR is far below the threshold.

In one embodiment, in response to determining that the processor will not maintain the wireless communication connection with a transmission power less than the initial target transmission power (NO in S1110), the processor may set the initial target transmission power as the final target transmission power (S1130). Thereafter, the processor may adjust the transmission power of the wireless communication to the final target transmission power (S1140).

FIG. 12 is a diagram showing an example of a lookup table 1200 according to one embodiment of the present disclosure. According to one embodiment, the electronic device 700 determines a minimum transmission power capable of maintaining the wireless communication connection based on status information of a signal received by the electronic device 700 via wireless communication. Based on the minimum transmission power, the electronic device determines whether the wireless communication connection is maintainable with an initial target transmission power or a transmission power within a range associated with the initial target transmission power.

For example, the electronic device 700 may determine the minimum transmission power that will maintain a wireless communication connection based on status information of a signal received via wireless communication. In one embodiment, the status information of a signal received by the electronic device 700 via wireless communication may include at least one of strength information (e.g., received signal strength indicator (RSSI), etc.) and quality information (e.g., signal noise ratio (SNR), etc.) of the signal received via wireless communication. As illustrated in FIG. 12, the status information is reflected in the left (or first) column of the lookup table 1200 and labeled “RSSI (dBm),” and the minimum transmission power is reflected in the right (or second) column of the lookup table 1200 and labeled “CONNECTION-MAINTAINABLE MINIMUM TRANSMISSION POWER.”

According to one embodiment, the electronic device 700 may use the lookup table 1200 to determine the minimum transmission power that will maintain the wireless communication connection based on the status information of the received signal. The lookup table 1200 includes a plurality of status information sets (e.g., listed in column 1 under RSSI (dBm)) and a minimum transmission power (e.g., listed in column 2 under CONNECTION-MAINTAINABLE MINIMUM TRANSMISSION POWER) that corresponds to each status information set of the plurality of status information sets. Each minimum transmission power represents the minimum transmission power capable of maintaining the connection of the wireless communication. For example, the lookup table 1200 may include a plurality of RSSIs and a connection-maintainable minimum transmission power corresponding to each of the plurality of RSSIs, as illustrated in FIG. 12. As an example, if the RSSI of a signal received by the electronic device 700 via wireless communication is-35 dBm, the minimum transmission power that will maintain the wireless communication connection is POWER_A. As another example, if the RSSI of a signal received by the electronic device 700 via wireless communication is −45 dBm, the minimum transmission power that will maintain the wireless communication connection is POWER_B. As another example, when the RSSI of a signal received by the electronic device 700 via wireless communication is greater than or equal to −45 dBm and less than or equal to −35 dBm, the minimum transmission power that may maintain a connection may be determined as a power greater than or equal to POWER_A and less than or equal to POWER_B, depending on the implementation.

Thereafter, the electronic device 700 may determine whether the wireless communication connection is maintainable with an initial target transmission power or a transmission power in a range associated with the initial target transmission power based on the determined minimum transmission power that will maintain the connection. For example, the electronic device 700 may determine whether a wireless communication connection is maintainable at the initial target transmission power by determining whether the initial target transmission power is greater than or equal to the minimum transmission power. For example, the status information (e.g., RSSI (dBm)) of the received signal may first be determined, and may be compared to the listed status information in column 1 of the lookup table 1200. The RSSI(dBM) of the received signal can correspond to one of the listed values in column 1 of the lookup table 1200. Next, the lookup table 1200 can be used to find the connection-maintainable minimum transmission power that corresponds to the value (e.g., in RSSI(dBM)) of the received signal. For example, if the value of the received signal is −55 dBm, then the connection-maintainable minimum transmission power may correspond to POWER_C. As another example, the electronic device 700 may determine whether a wireless communication connection is maintainable with a transmission power less than the initial target transmission power by determining whether the initial target transmission power exceeds the minimum transmission power.

The electronic device 700 has been described as an example of determining the minimum transmission power at which a wireless communication connection is maintainable by using the lookup table 1200, but the scope of the present disclosure is not limited to this example. For example, the electronic device 700 may determine the minimum transmission power that will maintain the wireless communication connection by using a formula that defines the relationship between the status information of the received signal and the minimum transmission power that will maintain the wireless communication connection. As another example, the electronic device 700 may determine the minimum transmission power to maintain the wireless communication connection using a machine learning model configured to output the minimum transmission power to maintain the wireless communication connection based on status information of the received signal. As another example, the electronic device 700 may determine whether the wireless communication connection is maintainable by using a machine learning model configured to output whether a connection is maintainable based on an initial target transmission power and status information of the received signal.

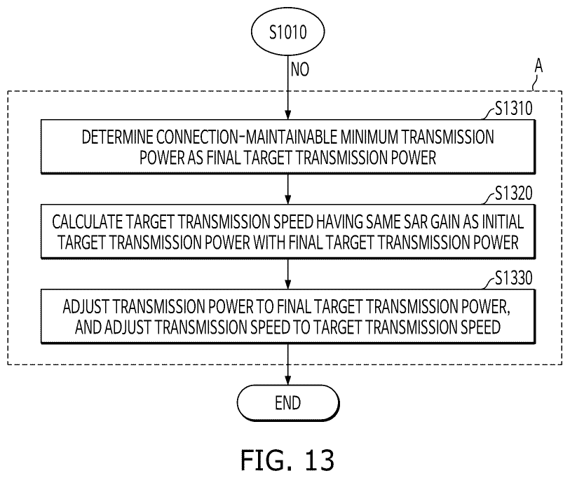

FIG. 13 is a flowchart showing another implementation example of part A of FIG. 10. Referring to FIG. 13, in response to determining that the initial target transmission power is less than the current transmission power (YES in S930) and that the wireless communication connection is not maintainable at the initial target transmission power (NO in S1010), the processor may determine the minimum transmission power at which the connection is maintainable, and set the minimum transmission power as the final target transmission power (S1310). Thereafter, the processor may calculate a target transmission speed, wherein the target transmission speed and the final target transmission power will have the same SAR gain as the SAR gain at the initial target transmission power (S1320). According to one embodiment, the processor may calculate the target transmission speed, under the final target transmission power, such that the target transmission speed and the final target transmission power will have a SAR gain equal to the SAR gain at the initial target transmission power. A transmission speed, under the final target transmission power, having the SAR gain equal to the SAR gain at the initial target transmission power may mean that when the transmission power is adjusted to the final target transmission power and the transmission speed is adjusted to the corresponding target transmission speed, a SAR reduction may be the same/similar to the SAR reduction achieved when only the transmission power is adjusted to the initial target transmission power. Thereafter, the processor may adjust the transmission power of the wireless communication to the final target transmission power and adjust the transmission speed of the wireless communication to the target transmission speed (S1330). In this case, the required degree of SAR reduction may be achieved by reducing the transmission power to a range that will maintain the wireless communication connection, and additionally by reducing the transmission speed.

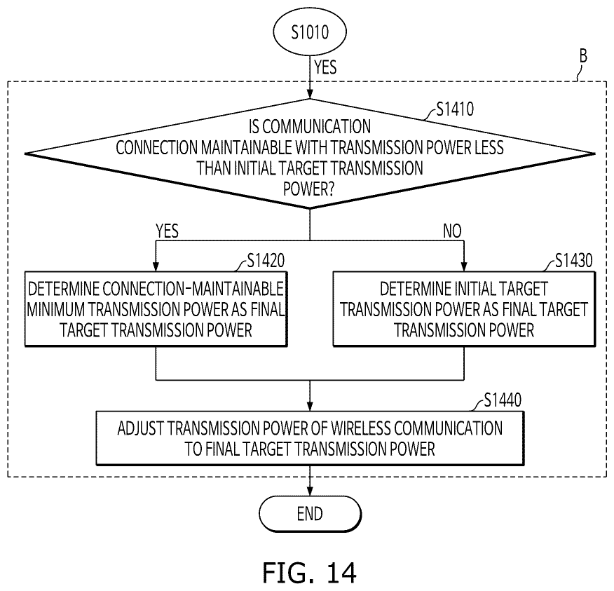

FIG. 14 is a flowchart showing another implementation example of part B of FIG. 10. Referring to FIG. 14, if the processor determines that the initial target transmission power is less than the current transmission power (YES in S930) and that the wireless communication connection is maintainable at the initial target transmission power (YES in S1010), the processor may determine whether the wireless communication connection is maintainable with a transmission power less than the initial target transmission power (S1410).

In one embodiment, in response to determining that the processor will maintain the wireless communication connection with a transmission power less than the initial target transmission power (YES in S1410), the processor may determine the minimum transmission power, at which the connection is maintainable, and may set the minimum transmission power as the final target transmission power (S1430). Thereafter, the processor may adjust the transmission power of the wireless communication to the final target transmission power (S1440). In this case, the available SAR budget may be efficiently managed by reducing the transmission power to a level beyond that required for current SAR management within a range that will maintain the wireless communication connection.

In one embodiment, in response to determining that the processor cannot maintain the wireless communication connection with a transmission power less than the initial target transmission power (NO in S1410), the processor may determine the initial target transmission power as the final target transmit power (S1430). Thereafter, the processor may adjust the transmission power of the wireless communication to the final target transmission power (S1140).

The flowcharts and the above description of FIGS. 9 to 11, 13 and 14 are only examples and may be implemented differently in some embodiments. For example, in some embodiments, the order of each step may be changed, some steps may be performed repeatedly, some steps may be added/changed/omitted, or the entity performing some steps may be changed. In addition, various features of the embodiments described herein can be combined and the embodiments are not necessarily mutually exclusive of each other, such that features of one of the embodiments can be combined, or used with, features of another embodiment.

The processors described herein (e.g., processor 120, 210, 720, etc.) may be a hardware circuit, such as a microprocessor, a CPU (Central Processing Unit), a GPU (graphics processor), a digital signal processor (DSP), a field-programmable gate array (FPGA), etc., and may be part of a computer. The processors may be configured by software such that the processors are configured to perform different functions. As is understood, “software” may refer to prescribed rules to operate a computer, such as code or script.

Methods of operating an electronic device may comprise determining a minimum transmission power at which the connection of the wireless communication is maintainable, wherein the minimum transmission power is determined based on status information of a signal received from an external electronic device via the wireless communication, and determining whether the connection of the wireless communication is maintainable at the initial target transmission power by determining whether the initial target transmission power is equal to or greater than the minimum transmission power.

In embodiments, the status information of the signal received via the wireless communication comprises at least one of strength information and quality information of the signal received via the wireless communication.

In embodiments, a determination of the minimum transmission power is made by using a lookup table comprising a plurality of state information and a corresponding minimum transmission power for each state information.

In embodiments, a determination of the minimum transmission power is made by using a machine learning model configured to output the minimum transmission power based on the status information of the signal received via the wireless communication.

In embodiments, methods of operating the electronic device may further comprise, in response to a determination that the connection of the wireless communication is not maintainable at the initial target transmission power: calculating a target transmission speed of the wireless communication resulting in a SAR gain equal to a SAR gain that would have resulted from the initial target transmission power without adjusting the transmission speed, and adjusting the transmission speed of the wireless communication to the target transmission speed.

In embodiments, methods may further comprise, in response to a determination that the connection of the wireless communication is not maintainable at the initial target transmission power: determining a minimum transmission power at which the connection is maintainable and setting the minimum transmission power as a final target transmission power, calculating a target transmission speed of the wireless communication, wherein the target transmission speed and the final target transmission power result in a SAR gain equal to a SAR gain that would have resulted from the initial target transmission power without adjusting the transmission speed, adjusting the transmission power of the wireless communication to the final target transmission power, and adjusting the transmission speed of the wireless communication to the target transmission speed.

In embodiments, methods of operating the electronic device may further comprise, in response a determination that the connection of the wireless communication is maintainable at the initial target transmission power: setting the initial target transmission power as a final target transmission power, and adjusting the transmission power of the wireless communication to the final target transmission power.

In embodiments, methods may comprise determining, in response to a determination that the connection of the wireless communication is maintainable at the initial target transmission power, whether the connection of the wireless communication is maintainable with a transmission power less than the initial target transmission power.

In embodiments, methods of operating the electronic device may further comprise, in response to a determination that the connection of the wireless communication is maintainable at a transmission power less than the initial target transmission power: setting a minimum transmission power that maintains the connection of the wireless communication as a final target transmission power, and adjusting the transmission power of the wireless communication to the final target transmission power.

In embodiments, methods of operating the electronic device may further comprise, in response to a determination that the connection of the wireless communication is not maintainable at a transmission power less than the initial target transmission power: setting the initial target transmission power as a final target transmission power, and adjusting the transmission power of the wireless communication to the final target transmission power.

In embodiments, methods may comprise determining, in response to the initial target transmission power being greater than or equal to the current transmission power, whether the connection of the wireless communication is maintainable at a transmission power less than the initial target transmission power.

In embodiments, methods may further comprise in response to a determination that the connection of the wireless communication is maintainable at a transmission power less than the initial target transmission power: determining a minimum transmission power at which the connection of the wireless communication is maintainable, and setting the minimum transmission power as a final target transmission power, and adjusting the transmission power of the wireless communication to the final target transmission power.

In embodiments, methods may further comprise, in response to a determination that the connection of the wireless communication is not maintainable at a transmission power less than the initial target transmission power: setting the initial target transmission power as a final target transmission power, and adjusting the transmission power of the wireless communication to the final target transmission power.

In embodiments, the SAR information comprises information on a time-averaged SAR (TAS) during a predefined time interval according to the wireless communication.

In embodiments, the wireless communication comprises wireless local area network (WLAN) communication.

1. An electronic device comprising:
a transceiver configured to transmit and receive a signal via wireless communication; and
at least one processor configured to adjust at least one of a transmission power of the wireless communication and a transmission speed of the wireless communication based on specific absorption rate (SAR) information associated with electromagnetic waves generated by the electronic device,
wherein the at least one processor is further configured to:
determine an initial target transmission power of the wireless communication based on the SAR information,
determine whether the initial target transmission power is less than a current transmission power of the wireless communication,
in response to a determination that the initial target transmission power is less than the current transmission power, determine whether a connection of the wireless communication of the electronic device is maintainable at the initial target transmission power, and
adjust at least one of the transmission power and the transmission speed of the wireless communication based on the determination of whether the connection of the wireless communication is maintainable at the initial target transmission power.

2. The electronic device as claimed in claim 1, wherein the at least one processor is further configured to:
determine a minimum transmission power at which the connection of the wireless communication is maintainable, wherein the minimum transmission power is determined based on status information of the signal received from an external electronic device via the wireless communication, and
determine whether the connection of the wireless communication is maintainable at the initial target transmission power by determining whether the initial target transmission power is equal to or greater than the minimum transmission power.

3. The electronic device as claimed in claim 2, wherein the status information of the signal received via the wireless communication comprises at least one of strength information and quality information of the signal received via the wireless communication.

4. The electronic device as claimed in claim 2, wherein a determination of the minimum transmission power is made by using a lookup table comprising a plurality of state information and a corresponding minimum transmission power for each state information.

5. The electronic device as claimed in claim 2, wherein a determination of the minimum transmission power is made by using a machine learning model configured to output the minimum transmission power based on the status information of the signal received via the wireless communication.

6. The electronic device as claimed in claim 1, wherein the at least one processor is further configured to:
in response to a determination that the connection of the wireless communication is not maintainable at the initial target transmission power, calculate a target transmission speed of the wireless communication resulting in a SAR gain equal to a SAR gain that would have resulted from the initial target transmission power without adjusting the transmission speed, and
adjust the transmission speed of the wireless communication to the target transmission speed.

7. The electronic device as claimed in claim 1, wherein the at least one processor is further configured to:
in response to a determination that the connection of the wireless communication is not maintainable at the initial target transmission power, determine a minimum transmission power at which the connection is maintainable and set the minimum transmission power as a final target transmission power,
calculate a target transmission speed of the wireless communication, wherein the target transmission speed and the final target transmission power result in a SAR gain equal to a SAR gain that would have resulted from the initial target transmission power without adjusting the transmission speed,
adjust the transmission power of the wireless communication to the final target transmission power, and
adjust the transmission speed of the wireless communication to the target transmission speed.

8. The electronic device as claimed in claim 1, wherein the at least one processor is further configured to:
in response a determination that the connection of the wireless communication is maintainable at the initial target transmission power, set the initial target transmission power as a final target transmission power, and
adjust the transmission power of the wireless communication to the final target transmission power.

9. The electronic device as claimed in claim 1, wherein the at least one processor is further configured to, in response to a determination that the connection of the wireless communication is maintainable at the initial target transmission power, determine whether the connection of the wireless communication is maintainable with a transmission power less than the initial target transmission power.

10. The electronic device as claimed in claim 9, wherein the at least one processor is further configured to:
in response to a determination that the connection of the wireless communication is maintainable at a transmission power less than the initial target transmission power, set a minimum transmission power that maintains the connection of the wireless communication as a final target transmission power, and
adjust the transmission power of the wireless communication to the final target transmission power.

11. The electronic device as claimed in claim 9, wherein the at least one processor is further configured to:
in response to a determination that the connection of the wireless communication is not maintainable at a transmission power less than the initial target transmission power, set the initial target transmission power as a final target transmission power, and
adjust the transmission power of the wireless communication to the final target transmission power.

12. The electronic device as claimed in claim 1, wherein the at least one processor is further configured to, in response to the initial target transmission power being greater than or equal to the current transmission power, determine whether the connection of the wireless communication is maintainable at a transmission power less than the initial target transmission power.

13. The electronic device as claimed in claim 12, wherein the at least one processor is further configured to:
in response to a determination that the connection of the wireless communication is maintainable at a transmission power less than the initial target transmission power, determine a minimum transmission power at which the connection of the wireless communication is maintainable, and set the minimum transmission power as a final target transmission power, and
adjust the transmission power of the wireless communication to the final target transmission power.

14. The electronic device as claimed in claim 12, wherein the at least one processor is further configured to:
in response to a determination that the connection of the wireless communication is not maintainable at a transmission power less than the initial target transmission power, set the initial target transmission power as a final target transmission power, and
adjust the transmission power of the wireless communication to the final target transmission power.

15. The electronic device as claimed in claim 1, wherein the SAR information comprises information on a time-averaged SAR (TAS) during a predefined time interval according to the wireless communication.

16. The electronic device as claimed in claim 1, wherein the wireless communication comprises wireless local area network (WLAN) communication.

17. An electronic device comprising:
a transceiver configured to transmit and receive a signal via wireless communication; and
at least one processor configured to adjust at least one of a transmission power of the wireless communication and a transmission speed of the wireless communication based on specific absorption rate (SAR) information associated with electromagnetic waves generated by the electronic device,
wherein the at least one processor is further configured to:
determine an initial target transmission power of the wireless communication based on the SAR information,
determine whether the initial target transmission power is equal to or greater than a current transmission power of the wireless communication,
in response to a determination that the initial target transmission power is equal to or greater than the current transmission power, determine whether a connection of the wireless communication of the electronic device is maintainable at a transmission power less than the initial target transmission power, and
adjust the transmission power of the wireless communication based on the determination of whether the connection of the wireless communication is maintainable at the transmission power less than the initial target transmission power.

18. The electronic device as claimed in claim 17, wherein the at least one processor is further configured to:
in response to a determination that the connection of the wireless communication is maintainable at a transmission power less than the initial target transmission power, determine a minimum transmission power at which the connection of the wireless communication is maintainable, and set the minimum transmission power as a final target transmission power, and
adjust the transmission power of the wireless communication to the final target transmission power.

19. The electronic device as claimed in claim 17, wherein the at least one processor is further configured to:
in response to a determination that the connection of the wireless communication is not maintainable at a transmission power less than the initial target transmission power, set the initial target transmission power as a final target transmission power, and
adjust the transmission power of the wireless communication to the final target transmission power.

20. A method of operating an electronic device comprising:
determining an initial target transmission power of a wireless communication based on specific absorption rate (SAR) information associated with electromagnetic waves generated by the electronic device;
determining whether the initial target transmission power is less than a current transmission power of the wireless communication;
in response to determining that the initial target transmission power is less than the current transmission power, determining whether, upon reducing the current transmission power to the initial target transmission power, a connection of the wireless communication of the electronic device is maintainable; and
adjusting at least one of a transmission power and a transmission speed of the wireless communication based on the determination of whether the connection of the wireless communication is maintainable at the initial target transmission power.
